(19) United States
(12) Patent Application Publication
(10) Pub. No.: US 2008/0002571 A1
(43) Pub. Date: Jan. 3, 2008

(54) Communication device for performing redundant data communication

(75) Inventors: Masahiro Maeda, Yokohama (JP); Akira Shimamura, Yokohama (JP); Sadaharu Fukutoyama, Yokohama (JP); Satoru Kagohashi, Yokohama (JP); Taiichiro Sakaguchi, Yokohama (JP); Yuuji Kubo, Yokohama (JP); Yoshiharu Ito, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/518,206

(22) Filed: Sep. 11, 2006

(30) Foreign Application Priority Data
Jun. 28, 2006 (JP) 2006-178762

(51) Int. Cl. H04J 3/14; H04L 12/56

(52) U.S. Cl. 370/225; 370/389

(57) ABSTRACT

In a communication system for transmitting/receiving redundant data between a first communication device and a second communication device, using first and second lines, the first communication device transmits first transmitting data to the first line, and also delays the first transmitting data by a prescribed time and transmits the delayed transmitting data to the second line as second transmitting data. The second communication device delays first receiving data inputted from the first line by the prescribed time and generates the delayed receiving data, and selects one of the second receiving data inputted from the second line and the delayed receiving data.

### CROSS REFERENCE TO RELATED APPLICATIONS

This application is based upon and claims the benefit of priority from the prior Japanese Patent Application No. 2006-178762, filed Jun. 28, 2006, the entire contents of which are incorporated herein by this reference.

### BACKGROUND OF THE INVENTION

1. Field of the Invention

The present invention relates to a communication device for performing redundant data communication between nodes, using two physical lines.

2. Description of the Related Art

Recently, with the multi-functions of control of a vehicle-mounted system and the like, digitalized bi-direction synchronous communication between nodes has become popular. In the conventional bi-directional synchronous communication system, physical line failures are coped with by providing two physical lines between nodes and simultaneously transmitting data (for example, see the following Patent reference 1). In radio communication and the like, line failures are coped with by transmitting/receiving the same data over one line a plurality of times (for example, see the following Patent reference 2).

Patent reference 1: Japan Patent Application Publication No. 08-088621

Patent reference 2: Japan Patent Application Publication No. 2002-077109

The above-described bi-directional synchronous communication system has the following problems.

In the system for simultaneously transmitting over two lines, a receiving node receives the data of two lines simultaneously. Therefore, if there is a failure, such as the power fluctuations of the receiving node and the like, the respective data of two lines both become abnormal. In this case, the data must be re-transmitted from a transmitting node and at shortest a subsequent cycle must be awaited to obtain the data. In this case, a cycle means the time unit of transmission/reception schedule common to a plurality of nodes. It takes time of one cycle or more to obtain normal data for this re-transmitting process.

Therefore, even when there is a failure in the receiving node, it is desired to obtain normal data in a short time.

In the system for transmitting/receiving the same data over one line a plurality of times, physical line failures cannot be coped with. When transmitting the same data in the same cycle a plurality of times, its cycle time increases compared with the case where data is transmitted only one time if communication speed is the same. Therefore, its communication time increases. However, if the cycle time is the same, its communication speed must be improved. Therefore, components which can operate in high speed are needed. However, since such components are generally expensive, the cost of the communication device increases.

Therefore, even when there is a failure in the receiving node, it is desired to obtain normal data using inexpensive components.

### SUMMARY OF THE INVENTION

It is an object of the present invention to obtain normal data in shorter time using inexpensive components when there is a failure, such as power fluctuations and the like, in a receiving node.

A first communication device comprises a transmission control device and a first delay device. The first communication device transmits redundant data to a second communication device, using first and second lines. The transmission control device transmits first transmitting data to the first line. The first delay device delays the first transmitting data by a prescribed time and transmits the delayed transmitting data to the second line as second transmitting data.

The second communication device comprises a second delay device and a reception control device. The second communication device receives the first and second transmitting data from the first and second lines. The second delay device delays the first transmitting data inputted from the first line by the prescribed time and outputs the delayed receiving data. The reception control device selects one of the second transmitting data inputted from the second line and the delayed receiving data outputted from the second delay device and outputs it.

### BRIEF DESCRIPTION OF THE DRAWINGS

FIG. 1 shows the principles of the first and second communication devices of the present invention;

FIG. 2 shows the configuration of the communication system;

FIG. 3 shows the phase relationship between lines;

FIG. 4 shows the configuration of a node device;

FIG. 5 shows the alignment of receiving data; and

FIG. 6 shows the communication specification between nodes.

### DESCRIPTION OF THE PREFERRED EMBODIMENTS

The preferred embodiments of the present invention are described in detail below with reference to the drawings.

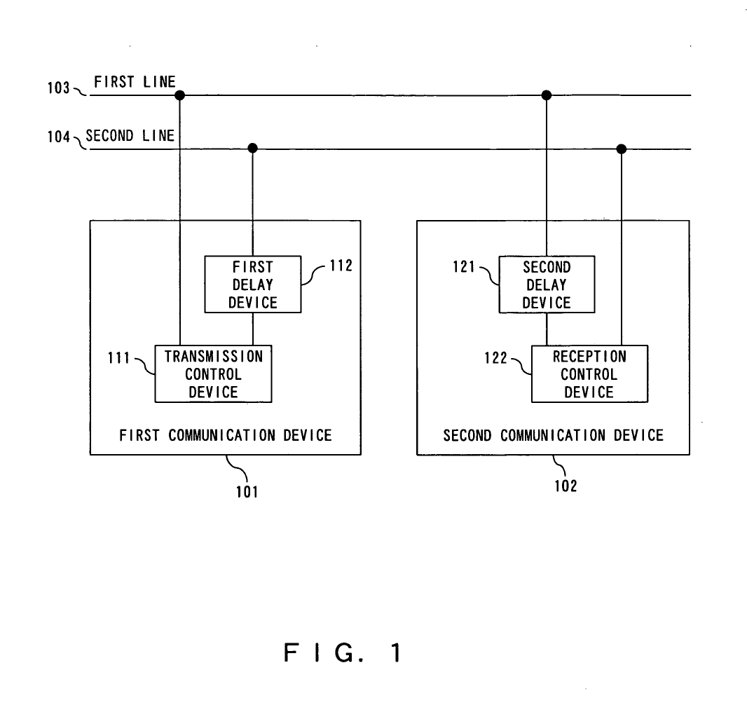

FIG. 1 shows the principles of the first and second communication devices of the present invention.

The first communication device 101 comprises a transmission control device 111 and a first delay device 112. The first communication device 101 transmits redundant data to the second communication device 102, using a first line 103 and a second line 104.

The transmission control device 111 transmits first data to the first line 103. The first delay device 112 delays the first transmitting data by a prescribed time and transmits the delayed transmitting data as second data to the second line 104.

The second communication device 102 comprises a second delay device 121 and a reception control device 122. The second communication device 102 receives the first and second transmitting data from the first line 103 and the second line 104.

The second delay device 121 delays the first transmitting data inputted from the first line 103 by the prescribed time and outputs the delayed receiving data. The reception control device 122 selects one of the second transmitting data inputted from the second line 104 and the delayed receiving data outputted from the second delay device 121 and outputs it.

Setting both of the delay times of the first delay device 112 and the second delay device 121 to the same time, two pieces of redundant data are transferred with shifted by the prescribed time over the first line 103 and the second line 104. The reception control device 122 can simultaneously receives those two pieces of data. Therefore, even when there are simultaneously failures on the first line 103 and the second line 104, the second communication device 102 can normally obtain one of the two pieces of data transmitted from the first communication device 101 without failing.

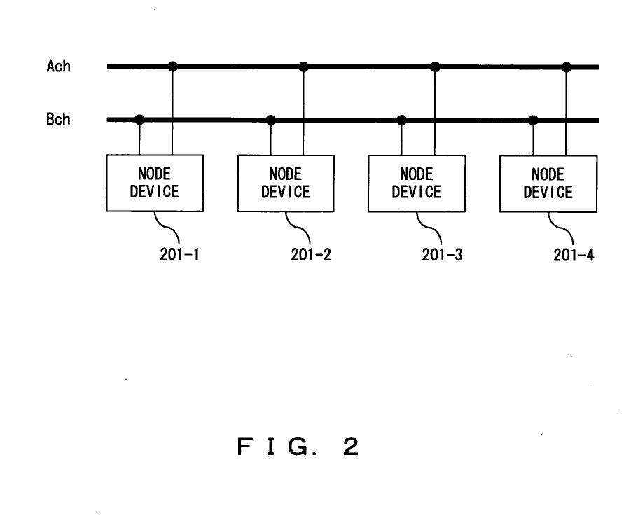

Each of the first communication device 101 and the second communication device 102 correspond, for example, to one of the node devices 201-1˜201-4 which is described with reference to FIG. 2. The first line 103 and the second line 104 correspond, for example, to the physical lines Ach and Bch, respectively, shown in FIG. 2.

The transmission control device 111, the first delay device 112, the second delay device 121 and the reception control device 122 correspond, for example, to the transmission control unit 413, buffer 411, buffer 412 and reception control unit 414, respectively.

According to the present invention, in addition to the fact that line failures can be coped with by the redundant configuration of two lines, by shifting the transmitting/receiving timing between lines, normal data can be obtained in a shorter time than a re-transmitting process when there is a failure in a receiving node.

Since there is no need to use expensive components unlike a system for receiving the same data over one line a plurality of times, the cost of the communication device can be suppressed.

FIG. 2 shows the configuration of the bi-directional synchronous communication system of the preferred embodiment. This system comprises four node devices 201-1˜201-4 and each node device is connected to two physical lines Ach and Bch. The number of node devices is not limited to four and is generally two or more.

For example, in case of a vehicle-mounted system, each node device is connected to a steering wheel control circuit, a brake control circuit and the like, and transmits/receives data necessary for its control. In the following description, node devices on the data transmitting and receiving sides are called “transmitting node device” and “receiving node device”, respectively.

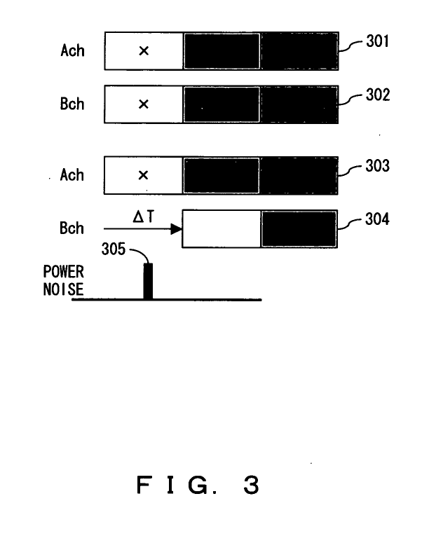

FIG. 3 shows an example of the phase relationship between lines of transmitting data shown in FIG. 2. In the conventional communication system, as shown in data signals 301 and 302, the transmitting node device transmits the same data to Ach and Bch with the same phase. Therefore, if there is a failure, such as power noise 305 in the receiving node device, the data of either selected line fails.

However, as shown in data signals 303 and 304, if the timing the data is transmitted to Ach and Bch is shifted, the same data can be transmitted with different phases. Thus, even when the data signal 303 of Ach fails due to the power noise 305, the data signal 304 of Bch which is not affected by the power noise 305 can be selected as normal data.

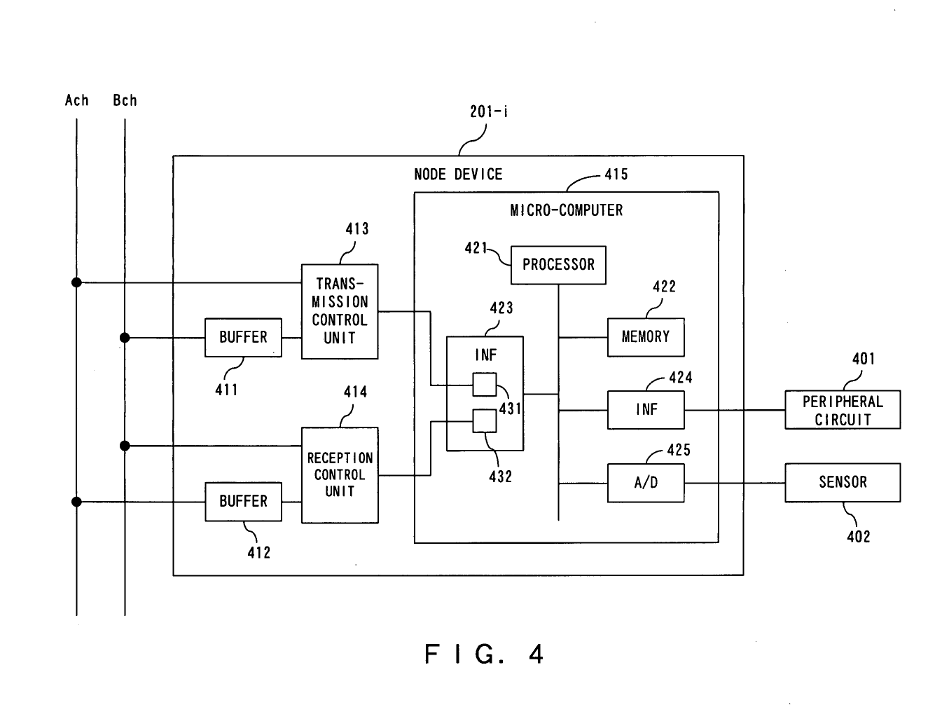

FIG. 4 shows the configuration of each node device shown in FIG. 2. A node device 201-i (i=1, 2, 3 and 4) comprises buffers 411 and 412, a transmission control unit 413, a reception control unit 414 and a micro-computer 415.

Each of the buffers 411 and 412 is made of a flip-flop circuit or a shift register circuit. They delay and output input signals. The transmission control unit 413 branches transmitting data into two pieces of data and outputs them. The reception control unit 414 selects and outputs one of the two pieces of receiving data.

The micro-computer 415 comprises a processor 421, memory 422, interfaces (INF) 423 and 424 and an analog/digital converter 425. The interface 424 and the analog/digital (A/D) converter 425 are connected to a peripheral circuit 401 and a sensor 402, respectively.

In the case of a vehicle-mounted system, the peripheral circuit 401 corresponds, for example, to a steering wheel control circuit, a brake control circuit and the like, and the sensor 402 corresponds, for example, to a distance sensor such as a laser device, a radar device and the like. The peripheral circuit 401 controls a steering wheel, a brake and the like, according to control signals from the micro-computer 415. The sensor 402 outputs analog signals including the distance information of an object in the neighborhood of a vehicle.

When transmitting data, the node device 201-i performs the following software (SW) process and a hardware (HW) process and transmits data to Ach and Bch.

### (1) SW Process

The analog/digital converter 425 converts an analog signal inputted from the sensor 402 to a digital signal. The processor 421 performs an operation process using the digital signal to calculate a value to be mapped in a communication frame and transfers a write request to the interface 423.

### (2) HW Process

In response to the write request from the processor 421, the interface 423 updates the value of the transmission register 431. The transmission control unit 413 maps the value of the transmission register 431 in two communication frames as transmitting data. Then, the transmission control unit 413 transmits one of the communication frames and the other to Ach and the buffer 411, respectively. The buffer 411 transmits the communication frame to Bch after delaying it by a prescribed time ΔT. Thus, as shown in FIG. 3, two pieces of the same data with different phases are transmitted to Ach and Bch.

When receiving data, the node device 201-i selects normal data after adjusting the phase difference between the lines. In this case, the buffer 412 transfers the communication frame from Ach to the reception control unit 414 after delaying it by ΔT.

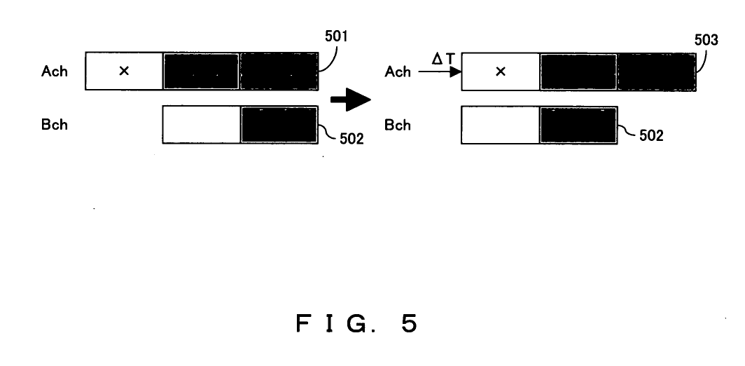

Thus, as shown in FIG. 5, only a data signal 501 from Ach is delayed by ΔT and is outputted to the reception control unit 414 as a data signal 503. Therefore, the data signal 503 and a data signal from Bch can be aligned and the phases of the two data signals can be matched.

Then, the node device 201-i performs the following HW and SW processes.

### (1) HW Process

The reception control unit 414 selects one of the communication frame from the buffer 412 and the communication frame from Bch, and writes receiving data included in the selected communication frame in the reception register 432 of the interface 423.

For example, even when there are simultaneous errors in the two lines of Ach and Bch due to power noise or the like in the node device 201-i, both of the communication frames including the same data never fail because the communication frame of Bch delays by ΔT from the communication frame of Ach, including the same data. Therefore, only one of the two aligned communication frames includes an error, and the other includes normal data.

Thus, the reception control unit 414 verifies the receiving data of both the communication frames, for example, by a cyclic redundancy check (CRC) to select normal data, and transfers the normal data to the interface 423. If both are normal, the data of a predetermined line is transferred to the interface 423.

The processor 421 transfers a read request to the interface 423. Then, the interface 423 transfers the value of the reception register 432 to the processor 421.

### (2) SW Process

The processor 421 performs an operation/priority process using the value transferred from the interface 423 and transfers the process result to the interface 424 as a control signal. The interface 424 outputs the control signal to the peripheral circuit 401.

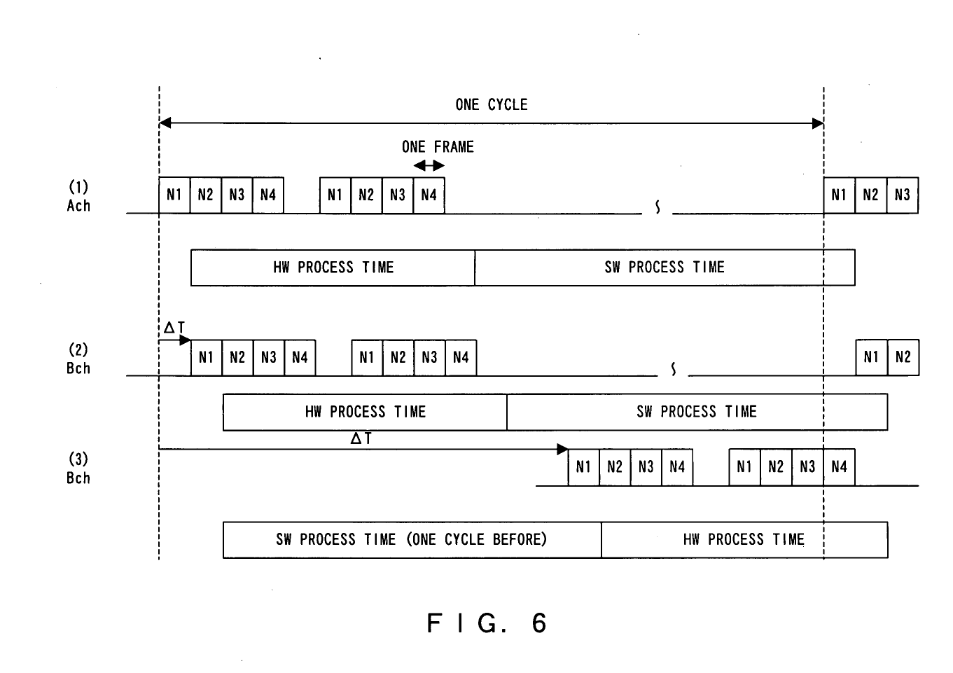

FIG. 6 shows the communication specification between nodes in the communication system shown in FIG. 2. In this example, the length of one cycle of a transmission/reception schedule shared by the node devices 201-1˜201-4 and the length of one communication frame transmitting a group of data of 10 Mb/s for each node are assumed to be 5 ms and 100 μs, respectively. N1-N4 represent communication frames including data for the node devices 201-1˜201-4, respectively.

In the communication specification between nodes, the total time of the HW and SW processes at the time of data reception must be within one cycle. Taking into consideration the time restrictions of the HW and SW processes, it is considered to be appropriate that the phase difference ΔT between lines is at shortest approximately one frame (100 μs) and at longest approximately half a cycle (2.5 ms). If the re-transmitting process of data is performed when there is a failure, data delays by at lest one cycle (5 ms). However, if ΔT=2.5 ms, normal data can be obtained with the delay of at longest half a cycle. Therefore, the restoration time can be shortened.

In FIG. 6, the HW process time and SW process time of a communication frame N1 in the receiving node device 201-1 in the three cases of ΔT=0, 100 μs and 2.5 ms are shown for the purpose of comparison.

### (1) In the Case of ΔT=0

The receiving node device 201-1 simultaneously receives the respective data signals of Ach and Bch. Then, at a time t1, the HW process of the communication frame N1 starts and then the SW process is performed.

### (2) In the Case of ΔT=100 μs

The receiving node device 201-1 receives the data signal of Bch one frame after the data signal of Ach. Then, at a time t2, the HW process of the communication frame N1 starts and then the SW process is performed.

### (3) In the Case of ΔT=2.5 ms

The receiving node device 201-1 receives the data signal of Bch half a cycle after the data signal of Ach. Then, at a time t3, the HW process of the communication frame N1 starts and then the SW process is performed.

Although in the configuration shown in FIG. 4, each node device is provided with both functions to transmit and to receive, only one function can also be provided. If it is a node device for transmission only, the buffer 412 and the reception control unit 414 can be omitted. If it is a node device for reception only, the buffer 411 and the transmission control unit 413 can be omitted.

What is claimed is:

1. A communication device for transmitting redundant data using first and second lines, comprising:
a transmission control device for transmitting first transmitting data to the first line; and
a delay device for delaying the first transmitting data by a prescribed time and transmitting the delayed transmitting data to the second line as second transmitting data.

2. The communication device according to claim 1, wherein
the delay device delays the first transmitting data by a time shorter than a data re-transmitting process, time at a time of failure.

3. The communication device according to claim 2, wherein
the delay device delays the first transmitting data by a time corresponding to a length of a communication frame.

4. A communication device for receiving redundant data from first and second lines, comprising:
a delay device for delaying first receiving data inputted from the first line by a prescribed time and outputting the delayed receiving data; and
a reception control device for selecting and outputting one of second receiving data inputted from the second line and delayed by the prescribed time from the first receiving data, and the delayed receiving data outputted from the delay device.

5. The communication device according to claim 4, wherein
the delay device delays the first receiving data by a time shorter than a data re-transmitting process time at a time of failure.

6. The communication device according to claim 5, wherein
the delay device delays the first receiving data by a time corresponding to a length of a communication frame.

7. The communication device according to claim 4, wherein
the reception control device verifies whether each of the second receiving data and the delayed receiving data is normal and selecting normal receiving data.

8. A communication system for transmitting/receiving redundant data between a first communication device and a second communication device, using first and second lines,
the first communication device comprising:
a transmission control device for transmitting first transmitting data to the first line; and
a first delay device for delaying the first transmitting data by a prescribed time and transmitting the delayed transmitting data to the second line as second transmitting data, and
the second communication device comprising:
a second delay device for delaying the first transmitting data inputted from the first line by the prescribed time and outputting the delayed receiving data; and
a reception control device for selecting and outputting one of the second transmitting data inputted from the second line and the delayed receiving data outputted from the second delay device.
